(19) United States
(12) Patent Application Publication
(10) Pub. No.: US 2008/0133091 A1
(43) Pub. Date: Jun. 5, 2008

(54) APPARATUS AND METHOD FOR ADJUSTING POSITION OF SIDE MIRROR CAMERA FOR VEHICLE

(76) Inventors: Jin Ho Park, Hwaseong-si (KR); Eui Yoon Chung, Seoul (KR)

Correspondence Address: MORGAN, LEWIS & BOCKIUS LLP (SF), One Market, Spear Street Tower, Suite 2800, San Francisco, CA, 94105, US

(21) Appl. No.: 11/777,161

(22) Filed: Jul. 12, 2007

(30) Foreign Application Priority Data
Dec. 1, 2006 (KR) 10-2006-0120496

(51) Int. Cl. B60R 1/00

(52) U.S. Cl. 701/49

(57) ABSTRACT

An apparatus for adjusting a position of a side mirror camera of a vehicle includes a light source at the rear of the vehicle, emitting light toward the front of the vehicle. An image processing unit matches an image obtained by the camera with a reference image. A control unit adjusts the position of the camera based on the matching of the images. A method of adjusting a position of a side mirror camera of a vehicle includes: providing a light source at the rear of the vehicle to emit light toward the front of the vehicle, obtaining an image with the camera, matching the image obtained by the camera with a reference image, and adjusting the position of the camera based on the result of the matching. The matching may include binarizing the image obtained by the camera.

### CROSS-REFERENCE TO RELATED APPLICATION

This application claims priority to, and the benefit of, Korean Patent Application No. 10-2006-0120496, filed on Dec. 1, 2006, the entire disclosure of which is hereby incorporated by reference.

### BACKGROUND OF THE INVENTION

1. Field of the Invention

The present invention relates to an apparatus and method for adjusting the position of a side mirror camera for a vehicle. The inventive apparatus and method use offset values of image pixels, obtained through a matching operation between a camera image of the vehicle and a reference image, to adjust the camera.

2. Description of Related Art

A rear side monitoring system detects and warns a driver of the presence of obstacles, such as vehicles, behind the driver's vehicle. A typical rear side monitoring system collects images of the space behind and next to the vehicle from a camera mounted on the vehicle, such as on a side mirror. To ensure accurate performance of the camera, it is important to accurately adjust the camera's position during vehicle assembly.

### SUMMARY OF THE INVENTION

An apparatus for adjusting a position of a side mirror camera of a vehicle includes a light source at the rear of the vehicle, emitting light toward the front of the vehicle. An image processing unit matches an image obtained by the camera with a reference image. A control unit adjusts the position of the camera based on the matching of the images.

A method of adjusting a position of a side mirror camera of a vehicle includes: providing a light source at the rear of the vehicle to emit light toward the front of the vehicle, obtaining an image with the camera, matching the image obtained by the camera with a reference image, and adjusting the position of the camera based on the result of the matching. The matching may include binarizing the image obtained by the camera.

The method may further include executing an error adjustment algorithm of a control unit, such as by outputting an offset on a Y-axis and an offset on an X-axis, directed to the result of the matching; and updating camera positioning information stored in the control unit, based on the offset.

### BRIEF DESCRIPTION OF THE DRAWINGS

The above and other features of the present invention will be described with reference to certain exemplary embodiments illustrated in the attached drawings, in which:

FIG. 1 is a schematic diagram illustrating a process of emitting light from the rear of a vehicle in accordance with an exemplary embodiment of the present invention.

FIG. 2 is a schematic diagram illustrating matching an obtained image to a reference image in accordance with an exemplary embodiment of the present invention.

FIG. 3 is a flowchart illustrating a method for adjusting the position of a side mirror camera for a vehicle in accordance with an exemplary embodiment of the present invention.

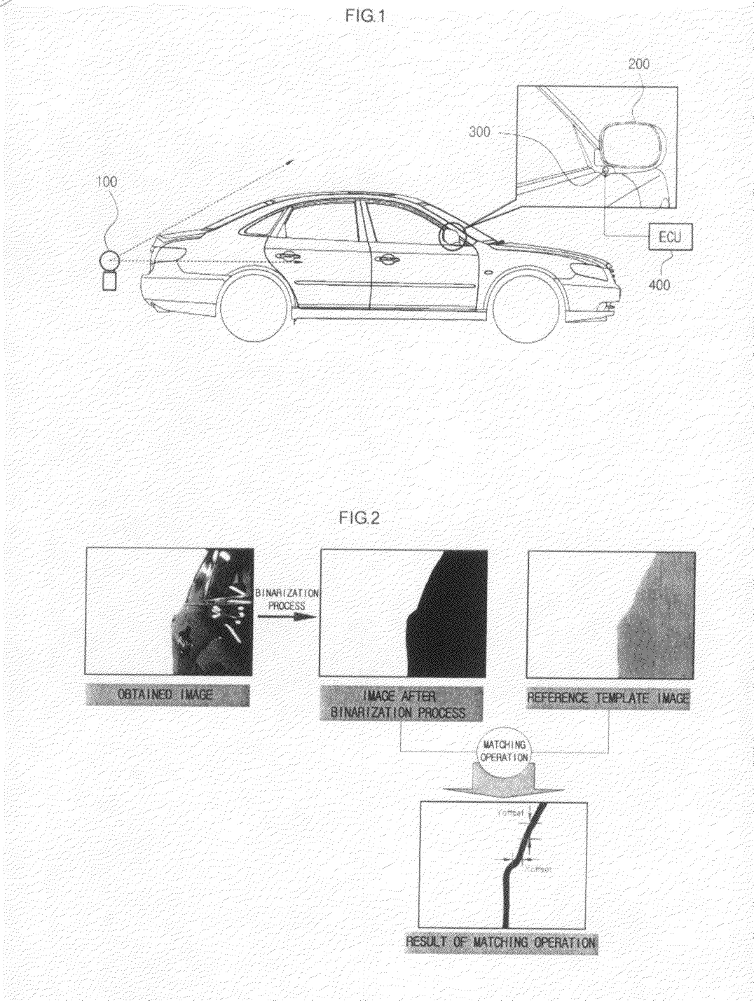

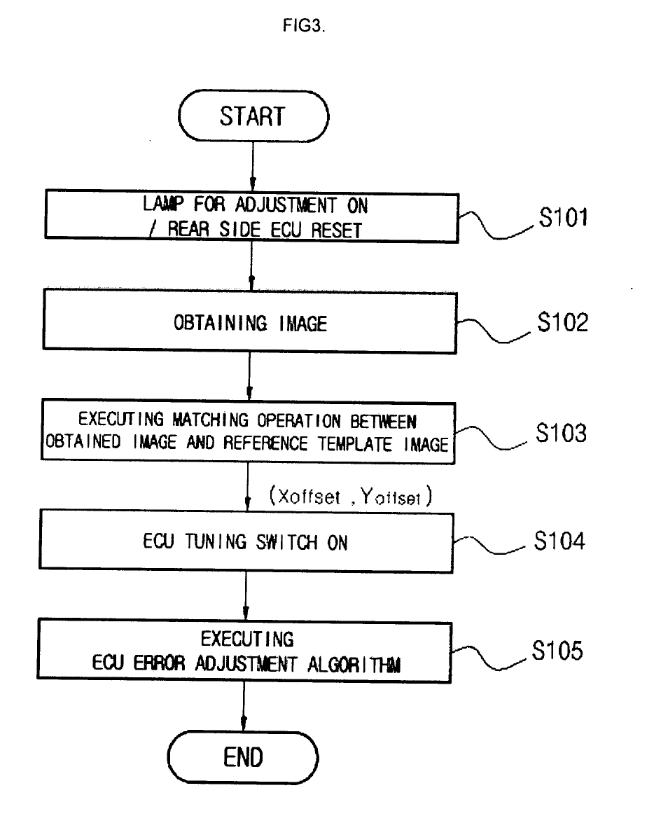

### DETAILED DESCRIPTION OF THE PREFERRED EMBODIMENTS

Hereinafter preferred embodiments of the present invention will now be described in detail with reference to the attached drawings.

First, a lamp 100 provided at the rear of a vehicle is turned on to emit light from the rear of the vehicle body forward (S101).

Next, a rear side of the vehicle (including front and rear doors) is photographed by a camera 300 mounted on a side mirror 200 (S102). As seen in the leftmost drawing in FIG. 2, the area outside the boundaries of the image of the vehicle (the left portion of the FIG.) is bright white due to the lamp 100, providing sharp contrast at the boundary of the image.

Next, the obtained image is matched to a reference template image by an image processing unit of the camera (S103). In more detail, the obtained image is binarization-processed to obtain an image showing the rear side line of the vehicle as black and the other area as white, as seen in the center drawing of FIG. 2. The binarization-processed image is subjected to the matching operation with the reference template image provided in advance (a reference image showing the state where the camera is accurately positioned) in the image processing unit of the camera.

If the binarization-processed image deviates from the reference template image in either the X-axis or Y-axis direction, the offset values, in units of number of pixels, are output to an ECU 400.

A worker then adjusts the position of the camera as much as the offset values dictate, and mounts the camera at the final position.

At the same time, if a switch for tuning the ECU is turned on (S104), the ECU executes an error adjustment algorithm based on the offset values (S105). That is, the ECU 400 automatically adjusts the camera positioning information stored in the ECU memory as much as the offset values.

While preferred embodiments of the present invention have been described and illustrated, the present invention is not limited thereto. On the contrary, it should be understood that various modifications and variations of the present invention can be made by those skilled in the art without departing from the spirit and the technical scope of the present invention as defined by the appended claims.

What is claimed is:

1. An apparatus for adjusting a position of a side mirror camera of a vehicle, comprising:
a light source, provided at a rear of the vehicle, and emitting light toward a front of the vehicle;
an image processing unit for matching an image obtained by the camera with a reference image; and
a control unit for adjusting the position of the camera based on the matching of the images.

2. A method of adjusting a position of a side mirror camera of a vehicle, comprising:
providing a light source at a rear of the vehicle to emit light toward a front of the vehicle;
obtaining an image with the camera;
matching the image obtained by the camera with a reference image; and
adjusting the position of the camera based on a result of the matching.

3. The method of claim 2, wherein the matching comprises binarizing the image obtained by the camera.

4. The method of claim 2, further comprising executing an error adjustment algorithm of a control unit.

5. The method of claim 4, wherein the error adjustment algorithm comprises:
outputting an offset directed to the result of the matching; and
updating camera positioning information stored in the control unit, based on the offset.

6. The method of claim 5, wherein the offset comprises an offset on a Y-axis and an offset on an X-axis.
